(19) United States
(12) Patent Application Publication
(10) Pub. No.: US 2011/0202768 A1
(43) Pub. Date: Aug. 18, 2011

(54) APPARATUS FOR MANAGING IDENTITY DATA AND METHOD THEREOF

(75) Inventors: Daeseon Choi, Daejeon (KR); Deokjin Kim, Daejeon (KR); Soohyung Kim, Daejeon (KR); Seunghyun Kim, Daejeon (KR); Jonghyouk Noh, Daejeon (KR); Kwansoo Jung, Daejeon (KR); Sangrae Cho, Daejeon (KR); Youngseob Cho, Daejeon (KR); Jinman Cho, Daejeon (KR); Seunghun Jin, Daejeon (KR)

(73) Assignee: Electronics and Telecommunications Research Institute, Daejeon (KR)

(21) Appl. No.: 13/124,900

(22) PCT Filed: Dec. 11, 2009
(86) PCT No.: PCT/KR2009/007417

§ 371 Date: Apr. 19, 2011

(30) Foreign Application Priority Data
Dec. 12, 2008 (KR) 1020080126708

(51) Int. Cl. H04L 9/32; H04L 9/08

(52) U.S. Cl. 713/168; 726/3; 380/283

(57) ABSTRACT

An apparatus and a method for managing identity data are disclosed, which can recover lost or deleted ID data stored in a user terminal and prevent a malicious user to plagiarize a user's ID. The apparatus includes a user ID management device (1), a back-up server (2) and a website system (3). The user ID management device (1) installed in a user's terminal allows ID data to be used on a website. The user ID management device (1) includes an ID management unit (10), a data storing unit (12), a back-up requesting unit (14) and a recovery requesting unit (16). A back-up server (2) backs up and stored ID data from the user ID management device (1). The back-up server includes a data storing unit (20), a back-up processing unit (22), a recovery processing unit (24), a suspension receiving unit (26) and a suspension requesting unit (28). A website system (3) includes a user account management unit (30), a suspension processing unit (32) and a recovery processing unit (34).

### TECHNICAL FIELD

The present invention relates to an apparatus for managing identity data and a method thereof, and more particularly, to an apparatus for managing identity data and a method thereof that can efficiently process back-up and recovery of identity data (ID data), and suspension and reuse of the id, etc. in a user-oriented ID management system.

### BACKGROUND ART

By rapid spread of ultrahigh-speed Internet services, e-commerce of business to business (B2B) and business to consumer (B2C) in addition to peer to peer (P2P) information exchange have been generalized.

However, in order to use services provided on Internet websites, users should perform a subscriber registration procedure requested by each website. The users should provide user's personal information such as a name, a resident registration number, an address, a contact number, etc. to service providers in a subscriber registration procedure. In some cases, in accordance with regulations for preparing the identifier and a password set in each website, different identifiers and passwords are issued for each website may be issued. Further, in order to use the service provided from each website, the users need to be authenticated for each website.

A more serious problem is in that it is difficult for the user to grasp information such as a management procedure of personal information provided from each website, a usage history of personal information, personal information shared between a website which a user subscribes to and other websites that have a collaborative relationship with the website, etc. Therefore, there is a high riskiness of privacy infringement and personal information abuse.

As a result, a research of a management system is needed, which gives a support to protect personal privacy and safely utilize personal information.

Recently, an Internet ID management solution has been proposed, which allows identifiers (hereinafter, referred to as id) and passwords used on the Internet, and personal information to be conveniently and safely used and managed. The identity (ID) in the Internet ID management solution can be defined as a set of attribute information used to identify users themselves in an online environment. Attributes (that is, identity data; hereinafter, referred to as ID data) constituting the identity (ID) variously include an identifier (id) for uniquely identifying the ID, credential information such as a password, a certificate, etc. which can used to certify an ID owner, an age, a contact number information, etc. In the case of the identity (ID), all ID data are not used but only some ID data may be used depending on types of transactions or roles which are performed by the user.

Among them, a user-oriented ID management technology forms one field, which allows the ID data to be stored in a user PC and used and managed as necessary.

In the user-oriented ID management technology, since the user controls submission and usage of the personal information in person, it is possible to ensure privacy of the user.

However, the user-oriented ID management technology stores all the ID data in the user PC unlike a service-type ID management technology that stores user's ID data in a predetermined server. Therefore, in the case when the ID data is lost or deleted, the user is restricted in using the Internet, which causes inconvenience to the user in recovering the lost or deleted ID data.

In particular, in order to move the ID data to another PC for use, the user-oriented ID management technology stores most of the ID data in a storage medium (portable medium) such as a USB memory, and connects the USB memory to another PC for use. In this case, when the storage medium (portable medium) is lost or stolen, a malicious user may plagiarize the ID.

### DISCLOSURE OF INVENTION

### Technical Problem

The present invention is contrived to solve the above-mentioned problems. An object of the present invention is to, when ID data stored in a user's terminal are lost or deleted, provide an apparatus for managing ID data and a method thereof that can easily recover the lost or deleted ID data.

Another object of the present invention is to, when user s ID data are lost, provide an apparatus for managing ID data and a method thereof that can prevent ID from being plagiarized by a malicious user and allow ID data to be recovered.

### Solution to Problem

In order to achieve the above-mentioned object, an apparatus for managing identity data according to a preferred embodiment of the present invention includes a data storing unit that backs up the identity data from a user terminal-based user ID management device managing the identity data and stores the identity data as back-up data; a recovery processing unit that transmits the back-up data stored in the data storing unit to the user ID management device at a recovery request from the user ID management device; and a suspension requesting unit that requests suspension of ID in a corresponding website of a corresponding website system on the basis of information in the data storing unit at an ID suspension request from an authenticated user.

The back-up data stored in the data storing unit are identity data of the authenticated user who requests the back-up.

The suspension requesting unit generates a recovery secret key and transmits the generated recovery secret key and an ID suspension request message including the ID in the corresponding website, which is stored in the data storing unit to the corresponding website system.

The suspension requesting unit stores the generated recovery secret key in the data storing unit.

The recovery processing unit transmits the corresponding back-up data and recovery secret key to the user ID management device at the recovery request from the user ID management device, which received after the ID suspension request.

An apparatus for managing identity data according to another embodiment of the present invention includes a data storing unit that stores identity data to be backed up to a back-up device; and a recovery requesting unit that recovers the identity data of the data storing unit by using the back-up data of the back-up device and performs reuse of the identity data.

The recovery requesting unit transmits a recovery request message including a user ID and a password for the back-up device to the back-up device, and receives the back-up data from the back-up device and stores the back-up data in the data storing unit.

The recovery requesting unit receives a recovery secret key and identity data from the back-up device and receives a new password from a corresponding website system by using the recovery secret key to perform ID reuse in the corresponding website system after ID suspension.

The recovery requesting unit stores the new password in the data storing unit.

A method of managing identity data according to an embodiment of the present invention includes a back-up step of allowing a data storing unit to back up the identity data from a user terminal-based user ID management device managing the identity data and store the identity data as back-up data; a recovery processing step of allowing a recovery processing unit to transmit the back-up data stored in the data storing unit to the user ID management device at a recovery request from the user ID management device; and a suspension requesting step of allowing a suspension requesting unit to request suspension of ID in a corresponding website of a corresponding website system on the basis of information in the data storing unit at an ID suspension request from an authenticated user.

The back-up data stored in the data storing unit are identity data of the authenticated user who requests the back-up.

In the suspension requesting step, the suspension requesting unit generates a recovery secret key and transmits the generated recovery secret key and an ID suspension request message including the ID in the corresponding website, which is stored in the data storing unit to the corresponding website system.

The method further includes a recovery secret key storing step of allowing the suspension requesting unit to store the generated recovery secret key in the data storing unit.

The method further includes a recovery step of allowing the recovery processing unit transmits the corresponding back-up data and recovery secret key to the user ID management device at the recovery request from the user ID management device, which received after the ID suspension request.

A method of managing identity data according to another embodiment of the present invention includes a data storing step of allowing a data storing unit to store identity data to be backed up to a back-up device; and a recovery step of allowing a recovery requesting unit to recover the identity data of the data storing unit by using the back-up data of the back-up device and performs reuse of the identity data.

The recovery step includes a step of transmitting a recovery request message including a user ID and a password for the back-up device to the back-up device, and receiving the back-up data from the back-up device and stores the back-up data in the data storing unit.

The recovery step includes a step of receiving a recovery secret key and identity data from the back-up device and receiving a new password from a corresponding website system by using the recovery secret key to perform ID reuse in the corresponding website system after ID suspension.

The method further includes a storing step of allowing the recovery requesting unit to store the new password in the data storing unit.

### Advantageous Effects of Invention

According to the above-configured present invention, it is possible to secure higher security by backing up ID data in a back-up server in comparison with a known case in which the ID data are stored in a storage medium (i.e., USB memory) and a known case in which the ID data are stored in a user PC. That is, it is possible to rapidly deal with a case in which ID data in a user ID management device are lost or deleted or an ID data storage medium is lost.

When the ID data stored in the user PC are lost or deleted, contents of the lost or deleted ID data are difficult to recover in the related art, while the lost or deleted ID data can be easily recovered by utilizing back-up data in a back-up server in the present invention, in the case when a user sets different ids, passwords, etc. in various websites. As a result, user convenience can be minimized.

Even though the storage medium storing the ID data is lost, it is possible to remedy a concern in regards to ID plagiarizing. That is, when the storing medium storing the ID data is lost, the ID data is recovered and id usage is resumed after usage of the existing id is stopped in a website system through the back-up server. Therefore, it is possible to prevent ID from being plagiarized by a malicious user.

### BRIEF DESCRIPTION OF DRAWINGS

FIG. 1 is a block configuration diagram of an embodiment in which an apparatus for managing identity data according to the present invention is adopted;

FIG. 2 is a flowchart for illustrating a back-up process of ID data in a method of managing identity data according to an embodiment of the present invention;

FIG. 3 is a flowchart for illustrating a process for recovering lost or deleted ID data in a method of managing identity data according to an embodiment of the present invention; and

FIGS. 4 to 6 are flowcharts for illustrating id suspension and recovery processes in a method of managing identity data according to an embodiment of the present invention.

### MODE FOR THE INVENTION

Hereinafter, an apparatus for managing identity data and a method thereof according to an embodiment of the present invention will be described with reference to the accompanying drawings. An apparatus for managing identity data and a method thereof according to the present invention are based on a user-oriented ID management technology.

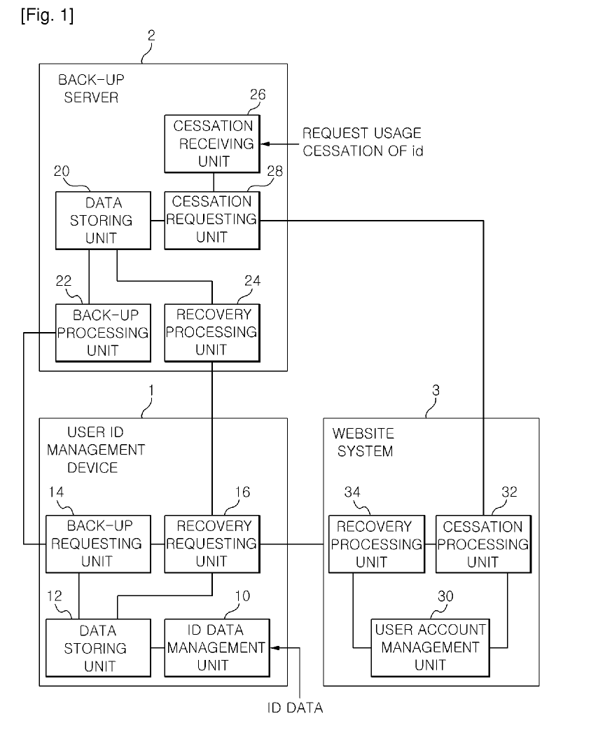

FIG. 1 is a block configuration diagram of an embodiment in which an apparatus for managing identity data according to the present invention is adopted.

The embodiment of FIG. 1 includes a user ID management device 1, a back-up server 2, and a website system 3.

The user ID management device 1 is installed in a user's terminal such as a user PC, etc. The user ID management device 1 can manage ID data to allow the ID data to be used on a website. In the specification below, ID data include a website name which a user subscribes to, an id and a password in the corresponding website, and personal information (user's name, resident registration number, address, phone number, etc.), for example.

The user ID management device 1 includes an ID data management unit 10, a data storing unit 12, a back-up requesting unit 14, and a recovery requesting unit 16.

The ID data management unit 10 stores all ID data (i.e., new ID data) inputted by the user or ID data of which some information is changed in the data storing unit 12.

The data storing unit 12 stores all ID data inputted through the ID data management unit 10 or ID data of which some information is changed. Further, the data storing unit 12 stores recovered ID data.

The back-up requesting unit 14 transmits the ID data stored in the data storing unit 12 to the back-up server 2 in order to back up the ID data. The back-up requesting unit 14 transmits a back-up request message to the back-up server 2 at a predetermined cycle or whenever the ID data stored in the data storing unit 12 are changed. The back-up request message includes a user id, an authentication secret key, ID data, etc. for the back-up server 2. Since the password and the personal information in the ID data are encrypted by an encryption secret key separately inputted by the user, the back-up server 2 cannot find a content of user's personal information. In addition, even though the ID data of the user PC adopting the user ID management device 1 are lost or deleted, the lost or deleted ID data can be recovered through the back-up server 2. Since a malicious user (i.e., a person who wants to plagiarize the ID) cannot find the user id and the authentication secret key for a well-intentioned user's back-up server 2, the malicious user cannot find a content of well-intentioned personal information. Therefore, the privacy of the well-intentioned user can be protected.

The recovery requesting unit 16 requests the back-up server 2 that a recovery operation using the ID data backed up in the back-up server 2 can be performed when the ID data stored in the data storing unit 12 are missed, lost, or deleted. The recovery requesting unit 16 transmits a recovery request message including the user id and password for the back-up server 2 to the back-up server 2 at the time of requesting the recovery of the ID data.

The recovery requesting unit 16 recovers the ID data by storing the back-up data from the back-up server 2 in the data storing unit 12. The recovery requesting unit 16 receives a new password from the website system 3 in order to resume usage of the id of the recovered ID data in the case of the recovery by the loss of the ID data.

The back-up server 2 backs up and stores the ID data from the user ID management device 1. The back-up server 2 provides the back-up data stored by the user's request to the user ID management device 1 again. The back-up server 2 requests suspension of id of the website by the user's request if the ID data may possibly be plagiarized due to the loss of the ID data.

The back-up server 2 includes a data storing unit 20, a back-up processing unit 22, a recovery processing unit 24, a suspension receiving unit 26, and a suspension requesting unit 28.

The data storing unit 20 stores the ID data transmitted from the user ID management device 1. The ID data stored in the data storing unit 20 serves as back-up data.

The back-up processing unit 22 receives the ID data transmitted from the user ID management device 1 and stores the ID data in the data storing unit 20. In other words, the back-up processing unit 22 performs user authentication through the user id and the authentication secret key for the back-up server 2 by the received back-up request message and when the authentication is normally completed, the ID data are stored in the data storing unit 20 by using the user id for the back-up server 2.

When the ID data are requested to be recovered, the recovery processing unit 24 extracts the corresponding back-up data stored in the data storing unit 20 and transmits the back-up data to the user ID management device 1.

The suspension receiving unit 26 receives a request for suspension of id. The suspension receiving unit 26 is constructed in the form of a web page, for example, in order to receive the request for suspension of the user id.

When the id suspension is requested, the suspension requesting unit 28 transmits an id suspension request message corresponding thereto to the website system 3. The suspension requesting unit 28 extracts a list of website names which the user subscribes to and ids in the corresponding websites from the data storing unit 20 and transmits the id suspension request message to the websites which the user subscribes to. The id suspension request message includes the id in the corresponding website and a recovery secret key generated by the suspension requesting unit 28. The recovery secret key generated by the suspension requesting unit 28 is used to generate a new password in the website system 3 when the usage of a recovered id is resumed after the id is suspended. Herein, the new password is used during a later log-in process.

The website system 3 means a system for implementing a general website. In FIG. 1, although only one website system 3 has been shown, it should be understood that a plurality of website systems 3 are provided.

The website system 3 includes a user account management unit 30, a suspension processing unit 32, and a recovery processing unit 34.

The user account management unit 30 manages a general user account. The user account includes user information (i.e., information required for user to log in the corresponding website system, such as user's identification number, name, password, etc.).

The suspension processing unit 32 performs the id suspension in accordance with the id suspension request message from the suspension requesting unit 28.

The recovery processing unit 34 resumes the suspended id in accordance with the recovery request message from the recovery requesting unit 16.

In FIG. 1, the back-up server 2 may be provided in plural. It is assumed that the website system 3 trusts one back-up server 2. Therefore, in order to suspend and recover the usage id for a website that trusts another back-up server, not the back-up server 2 which the user subscribes to, the back-up server which the corresponding website trusts should be passed. In FIG. 1, although an operation of passing between the back-up servers is not shown, it will be appreciated by those skilled in the art.

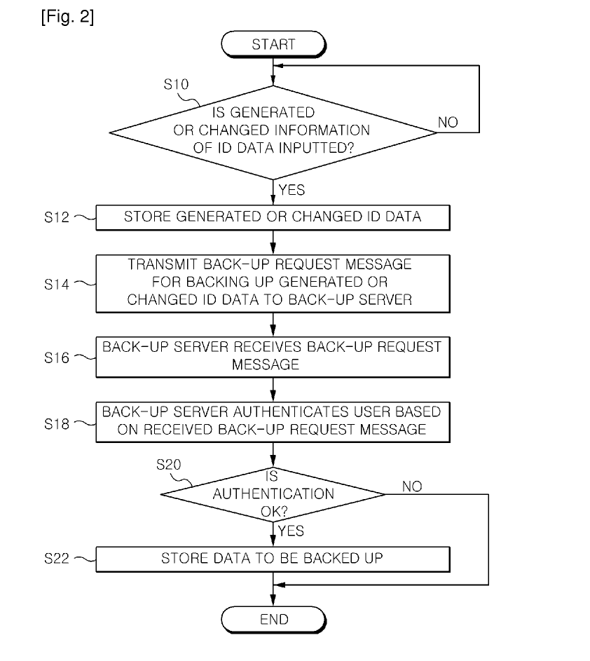

FIG. 2 is a flowchart for illustrating a back-up process of ID data in a method of managing identity data according to an embodiment of the present invention.

When ID data for new registration or information on ID data of which some of the contents are changed is inputted (“Yes” in S10), the ID data management unit 10 of the user ID management device 1, the new inputted ID data or the ID data of which some of the contents are changed in the data storing unit 12 (S12). Herein, in the case when the information on the ID data of which some of the contents are changed is inputted, the content of the corresponding item is updated.

As such, the ID data stored in the data storing unit 12 are transmitted to the back-up server 2 at a predetermined cycle or as necessary. That is, the back-up requesting unit 14 transmits a back-up message (a) including all ID data or the changed ID data to the back-up processing unit 22 of the back-up server 2 at a predetermined cycle or whenever the ID data stored in the data storing unit 12 are changed (S14). The back-up request message (a) includes a user id, an authentication secret key, a list of website names which the user subscribes to, ids, and passwords in the corresponding websites, and passwords, personal information, etc. for the back-up server 2. Since the passwords and the personal information are encrypted by an encryption secret key separately inputted by the user, the back-up server 2 cannot find the contents of the user's personal information. Accordingly, since even the malicious user cannot find the content of the well-intended user's personal information through the back-up server 2, the privacy of the well-intended user can be protected.

The back-up processing unit 22 receives the back-up request message (a) from the back-up requesting unit 14 (S16).

The back-up processing unit 22 authenticates the user through the user id and the authentication secret key for the back-up server 2 of the received back-up request message (a) (S18).

As a result of the user authentication, when it is authenticated that it is a normal user (i.e., a valid user) (“Yes” in S20), the back-up processing unit 22 stores the list of websites which the user subscribes to, the ids, and the passwords in the corresponding websites, and the user's personal information in the data storing unit 20 by using the user id for the back-up server 2 (S22).

By this configuration, back-up of the ID data to the back-up server 2 is completed. As such, when the ID data are backed up in the back server 2, it is possible to secure higher security than a case in which the ID data are stored in the storage medium (i.e., USB) and a case in which the ID data are stored in the user PC in the related art. That is, if even the ID data in the user ID management device 1 are lost or deleted or the ID data storage medium is lost, it is possible to rapidly deal with the cases.

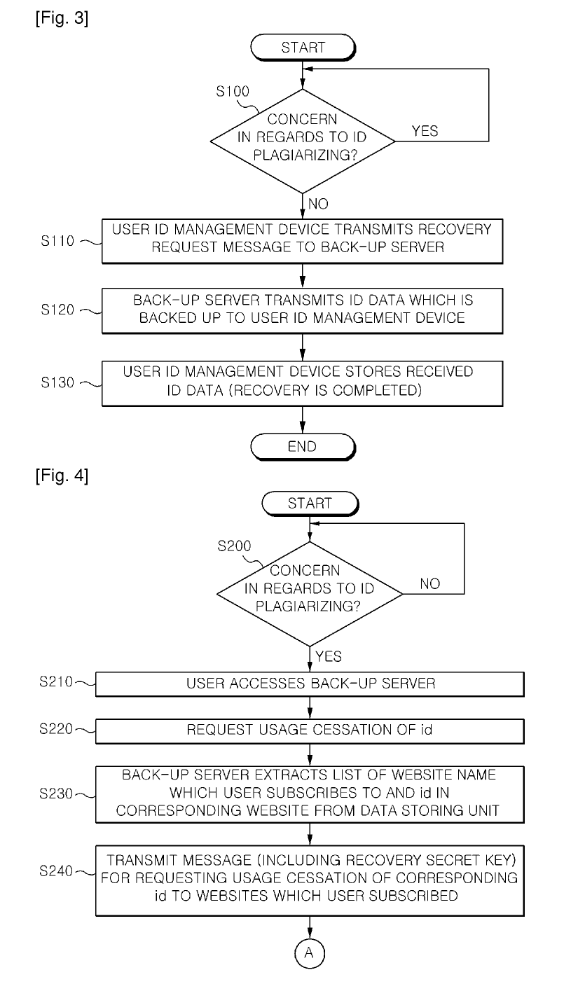

FIG. 3 is a flowchart for illustrating a process for recovering lost or deleted ID data in a method of managing identity data according to an embodiment of the present invention. In FIG. 3, it is assumed that the ID data stored in the data storing unit 12 of the user ID management device 1 are lost or deleted. When the ID data stored in the data storing unit 12 are lost or deleted, the ID data storage medium (i.e., USB memory) is not lost. Therefore, there is no wary about ID plagiarizing.

When there is no concern in regards to the ID plagiarizing (“Yes” in S100), the user transmits a recovery request message (b) to the recovery processing unit 24 of the back-up server 2 through the recovery requesting unit 16 (S110). The recovery request message (b) includes the user id and the password for the back-up server 2.

The recovery processing unit 24 that receives the recovery request message (b) transmits back-up data of the corresponding user's, which are stored in the data storing unit 20 to the recovery requesting unit 16 (S120).

The recovery requesting unit 16 stores the received back-up data in the data storing unit 12 (S130). Herein, the recovery requesting unit 16 decodes encrypted information among the received back-up data by using the encryption secret key inputted by the user and stores the decoded information in the data storing unit 12.

By this configuration, the lost or deleted ID data are recovered. When the ID data stored in the user PC are lost or deleted, the user can recover the contents of the lost or deleted ID data by accurately finding the contents in the related art. However, when the user sets different ids and passwords in various websites, the contents of the lost or deleted ID data is difficult to recover. On the contrary, as described in the present invention, it is possible to easily recover the lost or deleted ID data by performing the recovery process of the lost or deleted ID data.

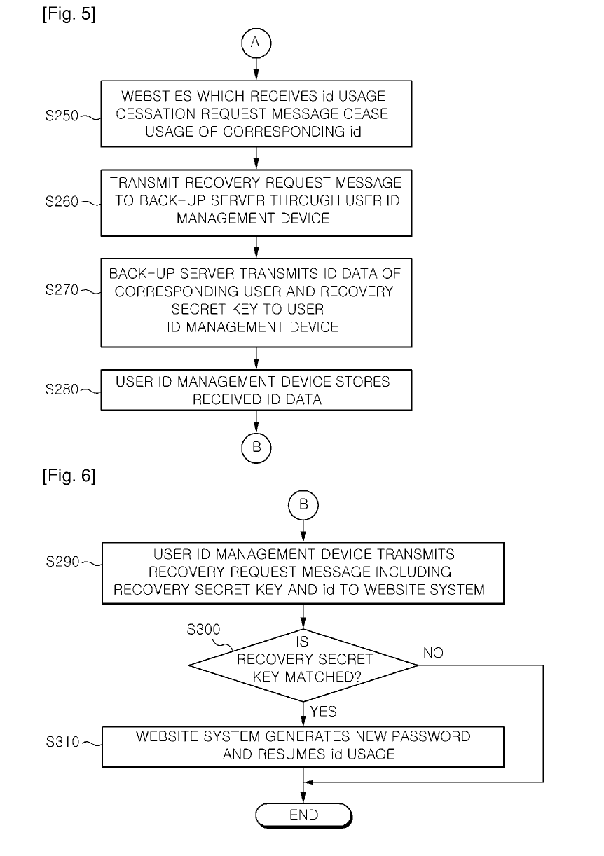

FIGS. 4 to 6 are flowcharts for illustrating id suspension and recovery processes in a method of managing identity data according to an embodiment of the present invention. In FIGS. 4 to 6, it is assumed that there is a concern in regards to ID plagiarizing due to the loss of the storage medium storing the ID data.

When there is the concern in regards to the ID plagiarizing due to the storage medium (i.e., USB memory, etc.) storing the ID data (“Yes” in S200), the user accesses to the back-up server 2 to request the id suspension (S210 and S220). That is, the user requests the id suspension through the suspension receiving unit 26 of the back-up server 2. At this time, the suspension receiving unit 26 performs the user authentication on the basis of the user id and password of the corresponding user for the back-up server 2.

When the request for the id suspension from the user, which is subjected to the normal user authentication, is transmitted to the suspension requesting unit 28, the suspension requesting unit 28 extracts the list of website names which the user subscribes to and the ids in the corresponding websites from the data storing unit 20 on the basis of the user id of the corresponding user for the back-up server 2 (S230).

The suspension requesting unit 28 transmits a message (i.e., an id suspension request message (c) for requesting the suspension of the corresponding id to the websites to which the corresponding user subscribes on the basis of the list of the website names which the user subscribes to and the ids in the corresponding websites. The id suspension request message (c) is transmitted to the website system 3 via another back-up server 2 when the back-up server 2 and the website system 3 have no trust relationship. The id suspension request message (c) includes the id in the corresponding website and the recovery secret key generated by the suspension requesting unit 28 (S240). The suspension requesting unit 28 stores the generated recovery secret key in the data storing unit 20 on the basis of the user id for the back-up server 2.

The suspension processing unit 32 of the website system 3 that receives the id suspension request message (c) transmits the id included in the received id suspension request message (c) to the user account management unit 30 and commands to suspend the corresponding id. Therefore, the user account management unit 30 suspends the corresponding id (S250). Herein, the suspension of the id disables log-in to be made through the existing password stored in the existing user ID management device 1, which may be possibly plagiarized due to the loss. By this configuration, even though the storage medium (i.e., USB memory) storing the ID data is lost, a malicious user who obtains the storage medium cannot plagiarize the ID data stored in the storage medium. Further, the suspension processing unit 32 stores the recovery secret key in the received id suspension request message (c) in a record of the user account management unit 30 for the corresponding id.

Thereafter, the user transmits a recovery request message (d) to the recovery processing unit 24 of the back-up server 2 through the recovery requesting unit 16 of the user ID management device 1 in order to recover the lost ID data (S260). The recovery request message (D) includes the user id and the password for the back-up server 2.

Therefore, the recovery processing unit 24 of the back-up server 2 extracts the corresponding back-up data (i.e., ID data which the corresponding user needs) and recovery secret key from the data storing unit 20 and transmits the back-up data and recovery secret key to the recovery requesting unit 16 (S270).

The recovery requesting unit 16 decodes encrypted information among the received back-up data by using the encryption secret key inputted by the user and stores the decoded information in the data storing unit 12 (S280).

After then, the recovery requesting unit 16 transmits a recovery request message (e) including the received recovery secret key and the id in the corresponding website to the recovery processing unit 34 of the website system 3 (S290).

The recovery processing unit 34 compares the recovery secret key included in the received recovery request message (e) and the recovery secret key stored in the user account management unit 30 and when the recovery secret keys are the same as each other (“Yes” in S300), the recovery processing unit 34 generates and transmits a new password to the recovery requesting unit 16 of the user ID management device 1. The recovery requesting unit 16 stores the new received password in the data storing unit 12 and uses the new password in later log-in. Further, the user account management unit 30 of the website system 3 resumes the usage of the user id in the corresponding website (S310).

By this configuration, even though the storage medium storing the ID data is lost, it is possible to minimize the concern in regards to ID plagiarizing. That is, when the storing medium storing the ID data is lost, the ID data is recovered and id usage is resumed by a new password after usage of the existing id is stopped in a website system 3 through a back-up server 2. Therefore, it is possible to prevent the ID from being plagiarized by a malicious user.

Meanwhile, although the present invention is not limited to the above-mentioned embodiments, it will be apparent those skilled in the art various changed and modifications may be made without departing from the scope of the invention as defined in the following claims.

1. An apparatus for managing identity data, comprising:
a data storing unit that backs up the identity data from a user terminal-based user ID management device managing the identity data and stores the identity data as back-up data;
a recovery processing unit that transmits the back-up data stored in the data storing unit to the user ID management device at a recovery request from the user ID management device; and
a suspension requesting unit that requests suspension of ID in a corresponding website of a corresponding website system on the basis of information in the data storing unit at an ID suspension request from an authenticated user.

2. The apparatus for managing identity data according to claim 1, wherein the back-up data stored in the data storing unit are identity data of the authenticated user who requests the back-up.

3. The apparatus for managing identity data according to claim 1, wherein the suspension requesting unit generates a recovery secret key and transmits the generated recovery secret key and an ID suspension request message including the ID in the corresponding website, which is stored in the data storing unit to the corresponding website system.

4. The apparatus for managing identity data according to claim 3, wherein the suspension requesting unit stores the generated recovery secret key in the data storing unit.

5. The apparatus for managing identity data according to claim 3, wherein the recovery processing unit transmits the corresponding back-up data and recovery secret key to the user ID management device at the recovery request from the user ID management device, which received after the ID suspension request.

6. An apparatus for managing identity data, comprising:
a data storing unit that stores identity data to be backed up to a back-up device; and
a recovery requesting unit that recovers the identity data of the data storing unit by using the back-up data of the back-up device and performs reuse of the identity data.

7. The apparatus for managing identity data according to claim 6, wherein the recovery requesting unit transmits a recovery request message including a user ID and a password for the back-up device to the back-up device, and receives the back-up data from the back-up device and stores the back-up data in the data storing unit.

8. The apparatus for managing identity data according to claim 6, wherein the recovery requesting unit receives a recovery secret key and identity data from the back-up device and receives a new password from a corresponding website system by using the recovery secret key to perform ID reuse in the corresponding website system after ID suspension.

9. The apparatus for managing identity data according to claim 8, wherein the recovery requesting unit stores the new password in the data storing unit.

10. A method of managing identity data, comprising the steps of:
a back-up step of allowing a data storing unit to back up the identity data from a user terminal-based user ID management device managing the identity data and store the identity data as back-up data;
a recovery processing step of allowing a recovery processing unit to transmit the back-up data stored in the data storing unit to the user ID management device at a recovery request from the user ID management device; and
a suspension requesting step of allowing a suspension requesting unit to request suspension of ID in a corresponding website of a corresponding website system on the basis of information in the data storing unit at an ID suspension request from an authenticated user.

11. The method of managing identity data according to claim 10, wherein the back-up data stored in the data storing unit are identity data of the authenticated user who requests the back-up.

12. The method of managing identity data according to claim 10, wherein in the suspension requesting step, the suspension requesting unit generates a recovery secret key and transmits the generated recovery secret key and an ID suspension request message including the ID in the corresponding website, which is stored in the data storing unit to the corresponding website system.

13. The method of managing identity data according to claim 12, further comprising:
a recovery secret key storing step of allowing the suspension requesting unit to store the generated recovery secret key in the data storing unit.

14. The method of managing identity data according to claim 12, further comprising:
a recovery step of allowing the recovery processing unit to transmit the corresponding back-up data and recovery secret key to the user ID management device at the recovery request from the user ID management device, which received after the ID suspension request.

15. A method of managing identity data, comprising:
a data storing step of allowing a data storing unit to store identity data to be backed up to a back-up device; and
a recovery step of allowing a recovery requesting unit to recover the identity data of the data storing unit by using the back-up data of the back-up device and performs reuse of the identity data.

16. The method of managing identity data according to claim 15, wherein the recovery step includes a step of transmitting a recovery request message including a user ID and a password for the back-up device to the back-up device, and receiving the back-up data from the back-up device and stores the back-up data in the data storing unit.

17. The method of managing identity data according to claim 15, wherein the recovery step includes a step of receiving a recovery secret key and identity data from the back-up device and receiving a new password from a corresponding website system by using the recovery secret key to perform ID reuse in the corresponding website system after ID suspension.

18. The method of managing identity data according to claim 17, further comprising:
a storing step of allowing the recovery requesting unit to store the new password in the data storing unit.
